(19) United States
(12) Patent Application Publication
(10) Pub. No.: US 2025/0342017 A1
(43) Pub. Date: Nov. 6, 2025

(54) SYSTEMS, METHODS, AND ARTICLES FOR CODE TRANSLATION AND PROGRAM SYNTHESIS BASED ON LARGE LANGUAGE MODELS

(71) Applicant: Code Metal, Boston, MA (US)

(72) Inventor: Peter Michael Morales, South Lake Tahoe, CA (US)

(21) Appl. No.: 18/653,474

(22) Filed: May 2, 2024

(51) Int. Cl. G06F 8/35; G06F 8/51

(52) U.S. Cl. CPC G06F 8/35; G06F 8/51

(57) ABSTRACT

Technologies for code-to-code translation and program synthesis are disclosed. An example method includes analyzing input source code to generate dependency graphs corresponding to the input source code, creating a set of code generation tasks for generating target code based on the dependency graphs, and feeding the set of code generation tasks to a trained large language model (LLM) to generate one or more parts of the target code.

### BACKGROUND

### Technical Field

The present disclosure generally relates to the field of code optimization and refinement, and more particularly, to using large language models (LLMs) for hardware-adaptive code generation and performance enhancement.

### Description of the Related Art

Transpilers, or source-to-source translators, are specialized tools that convert code from one high-level language to another. Functioning similarly to compilers, they can begin with processes such as tokenization and Abstract Syntax Tree (AST) generation, but instead of producing bytecode, they target high-level code. Transpilers can be essential for tasks such as migrating a codebase between different versions of the same language (e.g., from Python 2 to Python 3) and translating code from less complex languages (e.g., Python) to more performant ones (e.g., C or C++). Program synthesis, closely related to source-to-source translation, involves generating code that meets a specified set of requirements.

### BRIEF SUMMARY

For transpilers, although there are pre-defined libraries that facilitate conversion from Python to C or between other high-level languages, a universal transpilation method is yet to be developed. Typical transpilers may often yield outputs that are suboptimal and hard to read by humans. Source-to-source translation is typically limited to a subset of language features due to the unique characteristics and paradigms of each language, which do not always align.

On top of that, a major hurdle in program synthesis is the exploration of a vast array of potential programs. Various input specifications have been developed to direct this search. Neural networks have shown promise in effectively navigating this space, though they typically do so without verifiable guarantees. LLMs trained on problem sets such as LeetCode may generate code from natural language prompts, while tools such as code copilots may provide valuable autocompletion services to developers. However, these technologies are more effective with languages that have extensive code examples and are still prone to generating incorrect code, potentially leading to bugs or subtle code issues.

Generally speaking, the integration of neural models into code transpiling has been minimal, largely due to the lack of adequate parallel datasets in this area. It is recognized that LLMs for code translation have yet to achieve a dependable level of accuracy in automating code translation, with the success rate of accurate translations varying significantly. Detailed analyses have identified numerous categories of errors in the translations produced by LLMs, highlighting the challenges in achieving reliable automated code translation.

Moreover, there is a growing interest in leveraging high-level languages as intermediaries to facilitate the translation into low-level languages optimized for performance. This strategy has the potential to simplify the coding process and produce source code that can be more easily converted into efficient, low-level languages, representing a promising direction for enhancing code translation methodologies.

To address at least the above issues, this disclosure provides technologies capable of using a high-level input source language (e.g., Python) and generating a program that is human readable, idiomatic of its target language, and performant on a target hardware system. The disclosed technologies can be a more direct translation that is more emblematic of transpilers and/or optimize for a program synthesis task taking advantage of target language features and hardware properties.

Systems, methods, and articles for code translation and program synthesis are provided. In some embodiments, a method for source-to-source code translation and program synthesis includes: analyzing input source code to generate dependency graphs corresponding to the input source code; creating a set of code generation tasks for generating target code based, at least in part, on the dependency graphs; and feeding the set of code generation tasks to a trained large language model (LLM) to generate one or more parts of the target code.

In some embodiments, feeding the set of code generation tasks comprises interactively feeding individual code generation tasks in accordance with a dependency order. In some embodiments, the dependency order progresses from low-level dependencies to high-level dependencies.

In some embodiments, the method further comprises comparing the one or more parts of the target code with one or more corresponding parts of the input source code to identify at least one deficient part of the target code. In some embodiments, the comparing is based on at least one of a fuzzy metric or formal verification. In some embodiments, the method further comprises creating at least one generation task to regenerate the identified at least one deficient part.

In some embodiments, the LLM is trained on a multi-language data corpus for code-to-code translation.

In some embodiments, the method further comprises organizing the set of code generation tasks based, at least in part, on the dependency graphs for feeding the set to the trained LLM.

In some embodiments, the method further comprises establishing a context indicating at least one of target language primitives, accelerated functions, or code formatting rules, for generating the target code. In some embodiments, the method further comprises updating the context based, at least in part, on the generated one or more parts of the target code.

In some embodiments, a computing system comprises: one or more processors; and

one or more non-transitory computer-readable media collectively storing instructions that, when collectively executed by the one or more processors, cause the computing system to perform actions. The actions comprise: analyzing input source code to generate dependency graphs corresponding to the input source code; creating a set of code generation tasks for generating target code based, at least in part, on the dependency graphs; and feeding the set of code generation tasks to a trained machine learning model to generate one or more parts of the target code.

In some embodiments, feeding the set of code generation tasks comprises interactively feeding individual code generation tasks in accordance with a dependency order.

In some embodiments, the actions further comprise comparing the one or more parts of the target code with one or more corresponding parts of the input source code to identify at least one deficient part of the target code. In some embodiments, the comparing is based on at least one of a fuzzy metric or formal verification. In some embodiments, the actions further comprise creating at least one generation task to regenerate the identified at least one deficient part.

In some embodiments, a non-transitory computer-readable storage medium stores computer instructions that, when executed by one or more processors, cause the one or more processors to perform actions. The actions comprise: analyzing input source code to generate dependency graphs corresponding to the input source code; creating a set of code generation tasks for generating target code based, at least in part, on the dependency graphs; and feeding the set of code generation tasks to a trained machine learning model to generate one or more parts of the target code.

In some embodiments, the machine learning model is trained on a multi-language data corpus for code-to-code translation.

In some embodiments, the actions further comprise organizing the set of code generation tasks based, at least in part, on the dependency graphs for feeding the set to the trained machine learning model.

In some embodiments, the actions further comprise establishing a context indicating at least one of target language primitives, accelerated functions, or code formatting rules, for generating the target code. In some embodiments, the actions further comprise updating the context based, at least in part, on the generated one or more parts of the target code.

### BRIEF DESCRIPTION OF THE SEVERAL VIEWS OF THE DRAWINGS

Like-numbered elements may refer to common components in the different figures.

FIG. 1 is a block diagram illustrating a system including software components and data flow for code translation and program synthesis according to some embodiments of the present disclosure.

FIG. 2 is a flow diagram illustrating a process for code generation according to some embodiments of the present disclosure.

FIG. 3 is a flow diagram illustrating a process for code verification and optimization according to some embodiments of the present disclosure.

FIG. 4 is a block diagram illustrating a computing system or device used to implement some or all the functionalities of the technology disclosed herein.

### DETAILED DESCRIPTION

As discussed above, typical tools for code transpilation often target specific language pairs, may perform well for closely related languages or different versions of the same language by manually encoding changes. However, for vastly different languages, these tools typically produce output not human-readable and cover only a limited subset of source languages. Embodiments of the technologies disclosed herein can tackle these challenges by leveraging LLMs trained on synthetic or curated datasets, which can generate human-readable code (e.g., more similar to code produced by human developers), and synthesizing programs from natural language. By integrating these models with formal verification or code analysis tools, the degree of deviation of generated target code from the source code can be controlled, ranging from exact translation to equivalent outputs verified, e.g., through trace analysis and regression testing.

Although typical LLM-based methods have advanced program synthesis, including source-to-source transcoding, they struggle with large codebases and often produce inconsistent outputs. Embodiments of the presently disclosed technologies address these issues by segmenting the problem into smaller tasks through a generation task planner and caching parts of the generation, thus structuring the target codebase and simplifying output verification. The codebase can be iteratively traversed based on dependencies, gradually building up complex functions. Furthermore, by employing query-based methods or retrieval-augmented encoding, the system can adapt to the desired coding style and incorporate specific hardware knowledge into the generation process. This approach can aim to overcome the limitations of “stochastic parrot” tools such as LLMs that are typically used in code generation tasks.

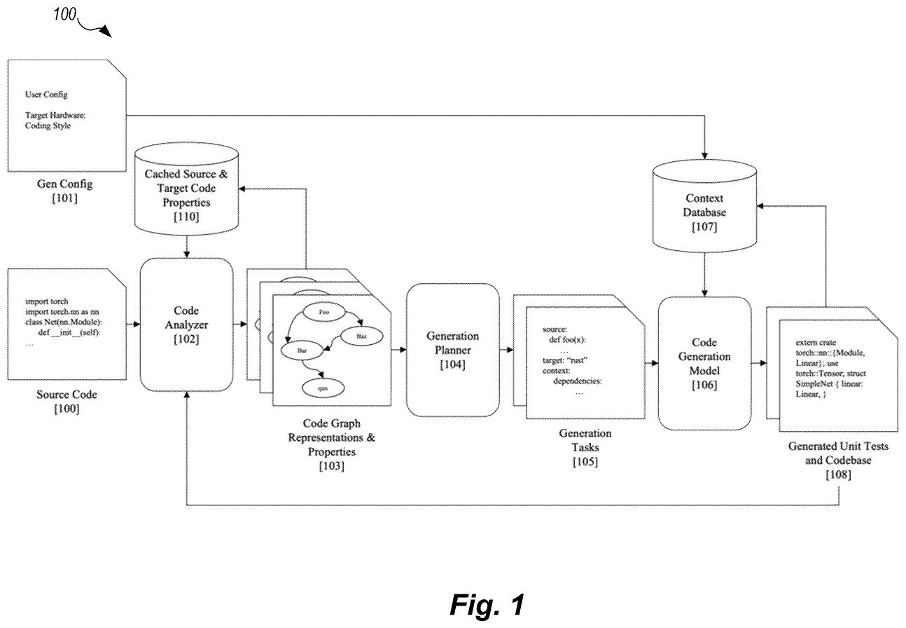

FIG. 1 is a block diagram illustrating a system 100 including software components and data flow for code translation and program synthesis according to some embodiments of the present disclosure.

The system 100 initiates a code translation process by establishing a context for generating target code in target language. Illustratively, establishing the context can be based on generation configuration input 101, which can include user configurations, target hardware specifications, target coding style, or the like. In some embodiments, the target language for code generation is explicitly specified, e.g., including any characteristics of the target language (e.g., variable names) that must be incorporated into the generated target code.

Illustratively, the context can define or otherwise indicate primitives of the target language that should be utilized, based on a specified format. The context can include a set of accelerated functions or other performance enhancing functions (e.g., matrix multiplications for GPU acceleration) that are not endemic to or dependent on the target language, which the system 100 can prioritize to leverage hardware-specific optimizations. The established context can be stored in context database 107. In some embodiments, e.g., where the generated code only needs to be translated from one language to another without specific platform concerns, the context can be minimized or not established.

Additionally or in the alternative, the context can define or otherwise indicate the code formatting rules for the output of target code, e.g., as guided by the input specifications based on source code and/or source language. These rules can ensure that the generated target code adheres to the stylistic and structural conventions of the target language, facilitating readability and maintainability. The context (or portions thereof) can be embedded directly in a query (e.g., a prompt to a LLM trained for code translation); if no formatting preferences are specified these rules can default to the LLM specific biases.

In some embodiments, the input source code 100 is explicitly specified and can dictate at least some transformation requirements. This specification can include details such as the syntactic and structural features of the source code that must be preserved in the translation. The source code specification in conjunctions with the established context can equip the system 100 with guidelines to produce code that is not only functional but also optimized for readability and performance in the target environment (e.g., hardware and/or software).

A code analyzer 102 can perform static analysis or other applicable structural analysis on input source code, generated target code (via a feedback loop), and/or parts thereof. The code analyzer 102 can create hierarchies, graphs, or other representations that cover the dependencies between structural blocks of code or code part(s), annotate as needed with meta data, and utilize traditional representations such as Abstract Syntax Trees (ASTs) or other code graphing methods to create the needed code representations to reason over. When analyzing generated target code, it can compare target code part(s) with corresponding cached input source code part(s) to ensure that they are sufficiently equivalent or similar to each other, based on fuzzy metrics or direct formal verification (e.g., based on their respective code graphs and/or other dependency relationships as represented). As such, the code analyzer 102 can provide the dependency representations and establish the domain for a generation planner 104 to optimize over; it can also detect and pinpoint problematic or deficient part(s) of generated target code (e.g., that do not meet specifications or input expectations, do not pass a equivalence or similarity threshold based on the comparison with corresponding portion of input source code, or incur compiler errors) for regeneration, without having to regenerate the entirety of the target code.

The code graph(s) or other dependency representation(s), along with associated metadata or other properties, can be cached in a database 110 for efficient access, comparison, deficiency identification, or the like; they also feed into a generation planner 104, which can use them as a basis to create generation tasks 105 (e.g., specific queries or prompts) to input into a code generation model 106 (e.g., a LLM trained for code translation). Each generation task can include its corresponding portion of the established context and can reference one or more dependencies on other files as well as other LLM queries. The generation tasks can be created in dependency order, e.g., progressing from low-level to high-level dependencies according to the dependency relationships of the input source code. Illustratively, this can be achieved by traversing tree or lattice structure(s) represented by the code graph(s). In various embodiments, the generation planner 104 can be implemented based on a set of predefined rules and actions; or it be a trained machine learning model (e.g., another LLM different than the code generation model 106). The generation planner can create generation tasks including customized solutions based on how the code generation should proceed, e.g., one file per function, one file per group of related functions, or the like.

The code generation model 106 can receive the generation tasks in accordance with their dependency order, and produce corresponding target code part(s). In some embodiments, the code generation model can include a LLM (or other applicable machine learning model) trained on a comprehensive corpus of multi-language data to be proficient in code-to-code translation. For languages with limited resources, the LLM can be fine-tuned to specialize in translating code across languages. Additionally, the code generation model can include smaller models tailored during training to focus on specific code-to-code translation tasks, thereby improving efficiency and lowering model size requirements. Based on the generation tasks, the code generation model can generate files in dependency order, and based thereon, further add to or otherwise update the established context of previous generations. The generated target code or code part(s) can be fed back into the code analyzer 102, so that subsequent generations can target specific issues identified from the target code or code part(s) of previous generations.

As described, the entire code generation process is iterative with the generated code from the code generation model being validated by the code analyzer and the process continuously targets areas for pinpointed code regeneration or refinement. In various embodiments, supplementary machine learning models (e.g., neural networks) can be trained to classify programs or pairs of code snippets. These models can be included or invoked by the code analyzer to assess whether programs or code parts in different languages are functionally similar or whether two programs in the same language accomplish the same task. Alternatively or in addition, heuristic comparison metrics can be employed to verify target code or parts thereof, restricting generations to more direct translation than program synthesis. Further, test harnesses (or other black box testing mechanism) can be added to code generation tasks, such that the output of the code generation model can also validate with unit tests against the corresponding original input source code. In some cases, specific tests can be manually added if desired rather than just generated unit test level changes. As such, the system is not only capable of translating code between languages but also verifying the semantic integrity of the translated code, thereby facilitating a more reliable and effective translation process.

Accordingly, embodiments of the presently disclosed technologies are capable of converting pseudo or source code into an equivalent target language codebase, complete with unit tests and specific optimizations. At least three technological aspects are involved. Firstly, at least due to the absence of a universal representation for robustly mapping between languages (e.g., Python and Rust), the presently disclosed technologies can adopt fuzzy or define metrics (e.g., trained neural networks, graph distance, or the like) to measure the similarity between generated code and input source, based on their code graph representations, traces, and/or generated unit tests. This allows for user control of the level of direct translation or opt for a more synthesis-like generation, facilitated by models trained on code transcoding data or traditional code analysis methods. Secondly, to at least counteract the tendency of LLMs to produce incorrect or “hallucinated” outputs, the presently disclosed technologies can employ planning tools to break down the code generation process into smaller, more manageable generation tasks (e.g., from functions to classes, from low dependencies to high dependencies, or the like). This approach not only simplifies verification but also ensures consistency across generations by caching specific segments of the codebase, preventing large-scale changes in output. Thirdly, the presently disclosed technologies use an iterative generation method, progressing from low-level to high-level dependencies and caching these part(s) or solution(s) for future reference. This iterative approach is combined with verification techniques to pinpoint and refine/regenerate deficient parts in the codebase without needing to redevelop the entire solution of target code. By integrating these aspects, the presently disclosed technologies provide a comprehensive framework for program synthesis from input source code, which aims to address significant challenges associated with large language models in program synthesis.

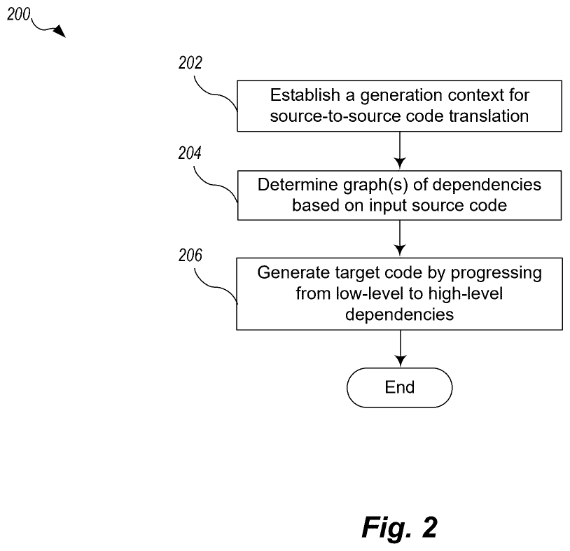

FIG. 2 is a flow diagram illustrating a process 200 for code generation according to some embodiments of the present disclosure. The process 200 can be performed by the system 100 as described with reference to FIG. 1.

The process 200 starts at block 202, where a context is established for source-to-source code translation. As described above with reference to FIG. 1, the context can be established by defining target language primitives, accelerated functions, and/or code formatting rules based on generation configuration inputs.

At block 204, the process 200 includes determining graph(s) or other representation(s) of dependencies based on input source code. As described above with reference to FIG. 1, static analysis or other applicable structural analysis can be performed on the input source code or parts thereof. Hierarchies, graphs, or other representations that cover the dependencies between structural blocks of code or code part(s) can be created, which can be associated with annotation meta data, properties, or attributes.

At block 206, the process 200 includes generating target code by progressing from low-level to high-level dependencies. As described above with reference to FIG. 1, target code generation can adhere to the stylistic and structural conventions of the target language and be optimized for performance and readability, based on the established context.

Target code can be generated by implementing an iterative generation process that progresses from low-level to high-level dependencies, utilizing cached solutions for efficiency and consistency in code generation. As described above with reference to FIG. 1, the generation planner can break down the code generation process into manageable sub-tasks, facilitating customized solutions and targeted improvements; the dynamic query-based method or retrieval-augmented encoding can adapt the generated code to desired coding styles and incorporate specific hardware settings, configuration, or knowledge; and the continuous validation and refinement of generated code through a cyclical process involving the code generation model and code analyzer, can ensure high-quality and accurate code output.

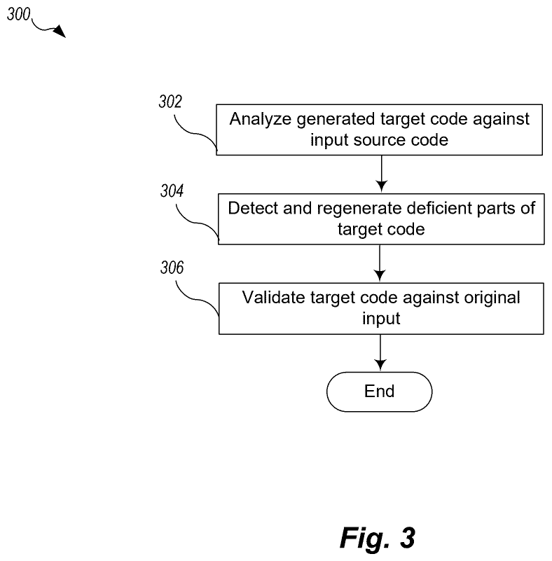

FIG. 3 is a flow diagram illustrating a process 300 for code verification and optimization according to some embodiments of the present disclosure. The process 300 can be performed by the system 100 as described with reference to FIG. 1.

The process 300 starts at block 302, where generated target code is analyzed against input source code. As described above with reference to FIG. 1, the analyzing can include a comparison to determine target-source equivalency or similarity, and to ensure target code's adherence to specifications.

At block 304, the process 300 includes detecting and regenerating deficient parts of target code. As described above with reference to FIG. 1, the code analyzer and/or generation planner can identify problematic or deficient parts in the target codebase to regenerate, without needing to redevelop the entire target code solution.

At block 306, the process 300 includes validating target code against original input. As described above with reference to FIG. 1, test harnesses or other black box tests can be incorporated into the code generation tasks for validating generated target code using the original input to source code, enhancing the reliability of the translation process.

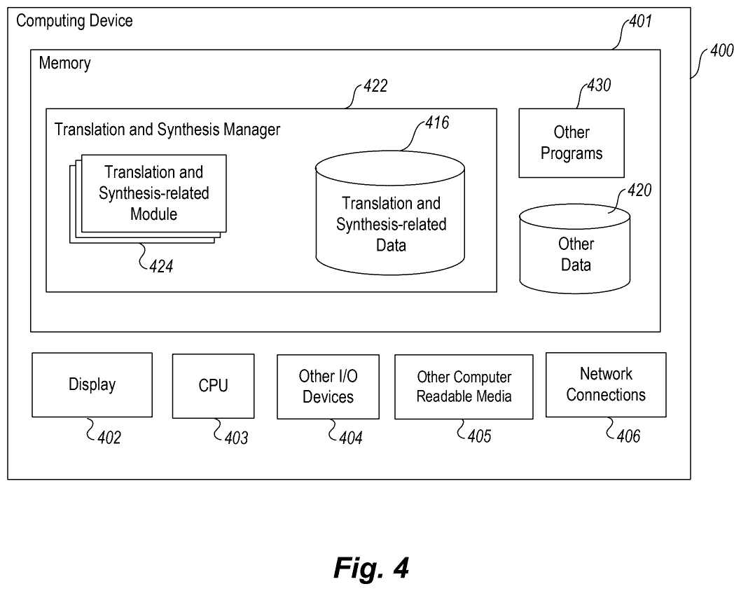

FIG. 4 is a block diagram illustrating a computing system or device 400 used to implement some or all the functionalities of the technology disclosed herein. According to some embodiments, one or more general purpose or special purpose computing systems or devices may be used to implement the computing device 400. In addition, according to some embodiments, the computing device 400 may comprise one or more distinct computing systems or devices and may span distributed locations. Furthermore, each block shown in FIG. 4 may represent one or more such blocks as appropriate to a specific embodiment or may be combined with other blocks. Also, the translation and synthesis manager 422 may be implemented in software, hardware, firmware, or in some combination to achieve the capabilities described herein.

As shown, the computing device 400 includes a non-transitory computer memory (“memory”) 401, a display 402 (including, but not limited to a light emitting diode (LED) panel, cathode ray tube (CRT) display, liquid crystal display (LCD), touch screen display, projector, etc.), one or more Central Processing Units (“CPU”) or other processors 403, Input/Output (“I/O”) devices 404 (e.g., keyboard, mouse, RF or infrared receiver, universal serial bus (USB) ports, High-Definition Multimedia Interface (HDMI) ports, other communication ports, and the like), other computer-readable media 405, and network connections 406. The translation and synthesis manager 422 is shown residing in memory 401. In other embodiments, some portion of the contents and some, or all, of the components of the translation and synthesis manager 422 may be stored on or transmitted over the other computer-readable media 405. The components of the computing device 400 and translation and synthesis manager 422 can execute on one or more CPUs 403 and implement applicable functions described herein. In some embodiments, the translation and synthesis manager 422 may operate as, be part of, or work in conjunction or cooperation with other software applications stored in memory 401 or on various other computing devices. In some embodiments, the translation and synthesis manager 422 also facilitates communication with peripheral devices via the I/O devices 404, or with another device or system via the network connections 406.

The one or more translation and synthesis-related modules 424 are configured to perform actions related, directly or indirectly, to the code translation, program synthesis, or other functionalities disclosed herein. In some embodiments, the translation and synthesis-related module(s) 424 stores, retrieves, or otherwise accesses at least some translation and synthesis-related data on some portion of the translation and synthesis-related data storage 416 or other data storage internal or external to the computing device 400.

Other code or programs 430 (e.g., further data processing modules, a program guide manager module, a Web server, and the like), and potentially other data repositories, such as data repository 420 for storing other data, may also reside in the memory 401, and can execute on one or more CPUs 403. Of note, one or more of the components in FIG. 4 may or may not be present in any specific embodiment. For example, some embodiments may not provide other computer-readable media 405 or a display 402.

According to some embodiments, the computing device 400 and translation and synthesis manager 422 include API(s) that provides programmatic access to add, remove, or change one or more functions of the computing device 400. In some embodiments, components/modules of the computing device 400 and translation and synthesis manager 422 are implemented using standard programming techniques. For example, the translation and synthesis manager 422 may be implemented as an executable running on the CPU 403, along with one or more static or dynamic libraries. In other embodiments, the computing device 400 and translation and synthesis manager 422 may be implemented as instructions processed by a virtual machine that executes as one of the other programs 430. In general, a range of programming languages known in the art may be employed for implementing such example embodiments, including representative embodiments of various programming language paradigms, including but not limited to, object-oriented (e.g., Java, C++, C #, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware embodiment, instructions stored in a memory configure, when executed, one or more processors of the computing device 400 to perform the functions of the translation and synthesis manager 422. In some embodiments, instructions cause the CPU 403 or some other processor, such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a translation and synthesis manager 422 embodiment. Also, other functions could be implemented or performed by each component/module, and in different orders, and by different components/modules, yet still achieve the functions of the computing device 400 and translation and synthesis manager 722.

In addition, programming interfaces to the data stored as part of the computing device 400 and translation and synthesis manager 422, can be available by standard mechanisms such as through C, C++, C #, and Java APIs; libraries for accessing files, databases, or other data repositories; scripting languages such as XML; or Web servers, FTP servers, NFS file servers, or other types of servers providing access to stored data. The model-related data storage 416 and data repository 420 may be implemented as one or more database systems, file systems, or any other technique for storing such information, or any combination of the above, including embodiments using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the translation and synthesis manager 422.

Furthermore, according to some embodiments, some or all of the components of the computing device 400 and translation and synthesis manager 422 may be implemented or provided in other manners, such as at least partially in firmware or hardware, including, but not limited to one or more application-specific integrated circuits (“ASICs”), standard integrated circuits, controllers (e.g., by executing appropriate instructions, and including microcontrollers or embedded controllers), field-programmable gate arrays (“FPGAs”), complex programmable logic devices (“CPLDs”), and the like. Some or all of the system components or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium or one or more associated computing systems or devices to execute or otherwise use, or provide the contents to perform, at least some of the described techniques.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A method for source-to-source code translation and program synthesis, the method comprising:
analyzing input source code to generate dependency graphs corresponding to the input source code;
creating a set of code generation tasks for generating target code based, at least in part, on the dependency graphs; and
feeding the set of code generation tasks to a trained large language model (LLM) to generate one or more parts of the target code.

2. The method of claim 1, wherein feeding the set of code generation tasks comprises interactively feeding individual code generation tasks in accordance with a dependency order.

3. The method of claim 2, wherein the dependency order progresses from low-level dependencies to high-level dependencies.

4. The method of claim 1, further comprising comparing the one or more parts of the target code with one or more corresponding parts of the input source code to identify at least one deficient part of the target code.

5. The method of claim 4, wherein the comparing is based on at least one of a fuzzy metric or formal verification.

6. The method of claim 4, further comprising creating at least one generation task to regenerate the identified at least one deficient part.

7. The method of claim 1, wherein the LLM is trained on a multi-language data corpus for code-to-code translation.

8. The method of claim 1, further comprising organizing the set of code generation tasks based, at least in part, on the dependency graphs for feeding the set to the trained LLM.

9. The method of claim 1, further comprising establishing a context indicating at least one of target language primitives, accelerated functions, or code formatting rules, for generating the target code.

10. The method of claim 9, further comprising updating the context based, at least in part, on the generated one or more parts of the target code

11. A computing system, comprising:
one or more processors; and
one or more non-transitory computer-readable media collectively storing instructions that, when collectively executed by the one or more processors, cause the computing system to perform actions, the actions comprising:
analyzing input source code to generate dependency graphs corresponding to the input source code;
creating a set of code generation tasks for generating target code based, at least in part, on the dependency graphs; and
feeding the set of code generation tasks to a trained machine learning model to generate one or more parts of the target code.

12. The system of claim 11, wherein feeding the set of code generation tasks comprises interactively feeding individual code generation tasks in accordance with a dependency order.

13. The system of claim 11, wherein the actions further comprise comparing the one or more parts of the target code with one or more corresponding parts of the input source code to identify at least one deficient part of the target code.

14. The system of claim 13, wherein the comparing is based on at least one of a fuzzy metric or formal verification.

15. The system of claim 13, wherein the actions further comprise creating at least one generation task to regenerate the identified at least one deficient part.

16. A non-transitory computer-readable storage medium storing computer instructions that, when executed by one or more processors, cause the one or more processors to perform actions comprising:
analyzing input source code to generate dependency graphs corresponding to the input source code;
creating a set of code generation tasks for generating target code based, at least in part, on the dependency graphs; and
feeding the set of code generation tasks to a trained machine learning model to generate one or more parts of the target code.

17. The non-transitory computer-readable storage medium of claim 16, wherein the machine learning model is trained on a multi-language data corpus for code-to-code translation.

18. The non-transitory computer-readable storage medium of claim 16, wherein the actions further comprise organizing the set of code generation tasks based, at least in part, on the dependency graphs for feeding the set to the trained machine learning model.

19. The non-transitory computer-readable storage medium of claim 16, wherein the actions further comprise establishing a context indicating at least one of target language primitives, accelerated functions, or code formatting rules, for generating the target code.

20. The non-transitory computer-readable storage medium of claim 19, wherein the actions further comprise updating the context based, at least in part, on the generated one or more parts of the target code
